(19) United States
(12) Patent Application Publication
(10) Pub. No.: US 2026/0317176 A1
(43) Pub. Date: Oct. 15, 2026

(54) METHODS AND MATERIALS FOR CONVERTING HYDROCARBONS TO HARD CARBON

(71) Applicant: CARBOMAT INC., Calgary (CA)

(72) Inventors: Md Golam Kibria, Calgary (CA); Vadivazhagen Mullaivananathan, Calgary (CA)

(21) Appl. No.: 19/644,620

(22) Filed: Apr. 10, 2026

Related U.S. Application Data
(60) Provisional application No. 63/786,854, filed on Apr. 10, 2025.

(51) Int. Cl. C01B 32/05; H01M 4/587; H01M 10/054

(52) U.S. Cl. CPC C01B 32/05; H01M 4/587; H01M 10/054; C01P 2002/72; C01P 2002/74; C01P 2002/82; C01P 2002/85; C01P 2004/03; C01P 2004/04; C01P 2006/40

(57) ABSTRACT

A method for forming hard carbon from an asphaltene precursor derived from bitumen. The asphaltene precursor is oxidized in an oxygen-rich atmosphere at one or more temperatures to produce an oxidized asphaltene. The oxidized asphaltene is then carbonised at an elevated temperature under an inert atmosphere to produce hard carbon having an interlayer spacing suitable for sodium-ion intercalation. The asphaltene precursor may be treated with an oxidizing agent prior to oxidizing at an elevated temperature. The method may further comprise milling the asphaltene precursor or the oxidized asphaltene to a powder after acid treatment, after oxidization at elevated temperature or after carbonization. The resulting hard carbon is suitable for use as an anode material in sodium-ion batteries.

### CROSS REFERENCE TO RELATED APPLICATION

This application claims benefit of U.S. provisional patent application No. 63/786,854 filed Apr. 10, 2025 titled METHODS AND MATERIALS FOR CONVERTING POLYCYCLIC AROMATIC HYDROCARBONS FROM BITUMEN INTO HARD CARBON FOR ENERGY STORAGE APPLICATIONS.

### BACKGROUND

### 1. Technical Field

This disclosure relates generally to forming carbon anodes and in particular to methods and materials for converting polycyclic aromatic hydrocarbons from bitumen or other carbon rich feedstockinto hard carbon.

### 2. Description of Related Art

The rising global demand for batteries has significantly accelerated the depletion of lithium resources, which are scarce and constitute only 0.006% of the Earth's crust. This increasing consumption of lithium has driven the cost of lithium carbonate (Li₂CO₃) to approximately 80,000 USD per metric ton in 2022. Such trends are expected to exacerbate the shortage of lithium in the future, further increasing the cost of devices reliant on lithium-based batteries. To address this challenge, recycling lithium or developing suitable alternatives is crucial. Sodium is one of the most promising alternatives to lithium, as both elements share similar physicochemical properties. For instance, the standard reduction potentials of lithium and sodium are −3.01 V and −2.81 V, respectively, while their theoretical capacities are 3860 mAh·g⁻¹ and 1165 mAh·g⁻¹. Moreover, sodium is abundantly available in the Earth's crust, and the cost of sodium carbonate (Na₂CO₃) was only 200 USD per metric ton in 2022. Although sodium has a lower theoretical capacity compared to lithium, its abundant and inexpensive resources can enable the development of more affordable batteries, making it a viable alternative to lithium-ion batteries (LIBs).

The research focused on sodium metal batteries originated from 1981 and reported the NaₓCoO₂ cathode material. Subsequently, the first full-cell sodium-ion batteries (SIBs) were introduced, utilizing NaNi_{0.5}Mn_{0.5}O₂ as the cathode and hard carbon as the anode. In 2018, SIBs were first applied in electric vehicles, and in 2021, the inaugural 100 MWh microgrid system powered by SIBs was launched. Currently, commercially utilized SIBs in electric vehicles achieve an energy density of approximately 120 Wh/kg, which is comparable to that of LIBs (160 Wh/kg). While the anode material in SIBs accounts for 13-16% of the total cost, it is slightly lower for LIBs, ranging from 11-13%. Increased anode cost is mainly due to the utilizing hard carbon (HC) an anode, it prices 4.31 CAD/100 g (ordering large quantities) which is higher than the artificial graphite (0.57-2.15 CAD/100 g) and natural graphite (0.5-1.29 CAD/100 g). Graphite anode is practically not suitable for SIBs, due to its low capacity, irreversible sodium accommodation during cycling process due to their lower interlayer spacing value (~0.335 nm), and serious SEI (solid electrolyte interlayer) formation with the electrolyte which inhibits the sodium-ion cycling. The hard carbon (HC) is widely used as an anode material for the sodium-ion batteries due to their low voltage capacity, suitable interlayer spacing for accommodating sodium, specific capacity, rate capability, cycle stability and it has the potential for large scale applications. Despite, the low initial Coulombic efficiency (ICE) and high production costs associated with reported hard carbons remain critical challenges requiring further investigation.

The cost of the HC anode primarily increased from the raw material source and synthesizing methods. HC from wood lignin (Stora Enso), coconut shell (Kuraray), coal tar (JFE), petroleum pitch (Kureha) and phenolic resin (BCD, Sumitomo Bakelite) are some of the commercially available HCs in the global market. In the series of the utilized HC raw material, the present disclosure is focused on the low-cost bitumen byproduct waste derived hard carbon anode for SIBs. In 2017, Canada, possessing vast bitumen reserves, produced 2.8 million barrels per day, underscoring its critical role as a primary feedstock for petroleum products. Asphaltenes is a waste material, byproduct from bitumen or crude oil, and the selling price is around $0.029 CAD/lbs. Generally, asphaltenes consists of carbon, oxygen, nitrogen, sulfur, and other metal constituents such as iron (Fe), vanadium (V), nickel (Ni), and silicon (Si). It is carbon rich (nearly 80-90 wt. %) material and cheapest, could be a suitable source for producing cost-effective hard carbon material.

Prior to the present disclosure, reports have not discussed hard carbon from asphaltenes in SIBs, although asphaltenes-based carbons are utilized for supercapacitor applications. Bitumen, commonly referred to as asphalt, has been employed as a precursor for synthesizing mesoporous/hard carbon, which has been systematically evaluated for its electrochemical performance in SIBs. Jia et al. synthesized Fe₂O₃-templated mesoporous carbon derived from spent asphalt and evaluated its electrochemical performance for lithium, sodium, and potassium-ion storage. The material exhibited a sodium storage capacity of 300 mAh·g⁻¹ with an initial Coulombic efficiency (ICE) of 85% at a current density of 50 mA g⁻¹, with the sodium-ion storage mechanism being predominantly capacitive. Chen et al. synthesized hard carbon from asphalt and enhanced its electrochemical performance through the oxidation of asphaltene precursors during pre-carbonization. The resulting material exhibited a capacity of 300 mAh g⁻¹, including a significant low-voltage plateau capacity of 171 mAh g⁻¹, and an initial Coulombic efficiency (I.C.E.) of 83.59% at a current density of 20 mA g⁻¹. The crosslinking of C—O and C(O)—O into petroleum asphalt, optimized for crosslinking time and temperature, was found to significantly improve electrochemical properties. The incorporation of C(O)—O promoted the formation of a three-dimensional crosslinked structure with the asphalt precursor, which mitigated the sliding of carbon layers during carbonization and controlled graphitization at elevated temperatures. Additionally, the introduction of oxygen-containing functional groups, including aldehydes, carboxyls, esters, and anhydrides, facilitated the formation of closed pores and ultra-micropores. This structural optimization minimized electrolyte decomposition during the formation cycle, resulting in an improved initial ICE value. In addition to that, it improves the capacity values by the formation of more active sodium sites.

### SUMMARY OF THE DISCLOSURE

According to a first embodiment of the present disclosure there is a method for forming hard carbon, the method comprising oxidizing an asphaltene precursor in an oxygen-rich atmosphere at one or more temperatures to produce an oxidized asphaltene and carbonising the oxidized asphaltene at an elevated temperature under an inert atmosphere to produce hard carbon having an interlayer spacing suitable for sodium-ion intercalation.

The oxygen-rich atmosphere may be air. The oxidizing may comprise heating the asphaltene precursor at a plurality of temperatures. The oxidizing may comprise heating the asphaltene precursor to a first temperature and maintaining the first temperature for a first period, and subsequently heating to a second temperature higher than the first temperature and maintaining the second temperature for a second period. The first temperature may be about 260° C. and the second temperature may be about 800° C. The oxidizing may be conducted at a temperature in the range of 260° C. to 800° C.

The method may further comprise milling the asphaltene precursor or the oxidized asphaltene to a powder, wherein the milling is performed at one or more of: prior to acid treatment, after acid treatment, after oxidizing, or after carbonising.

The carbonising may be conducted at a temperature in the range of 1200° C. to 1800° C. The carbonising may be conducted at a temperature of about 1500° C. The carbonising may be conducted for a period of time selected to be between 5 minutes and 5 hours. The carbonising may be conducted at a heating rate selected to be between about 0.5° C. and 10° C. per minute. The inert atmosphere may comprise an inert gas.

The method may further comprise oxidizing the asphaltene precursor with an oxidizing chemical prior to oxidizing in an oxygen-rich atmosphere at one or more temperatures. The acid may comprise an acid.

The hard carbon may be for use in sodium-ion battery anodes. The hard carbon may have a carbon content of at least 85 wt. %. The hard carbon may have a sulfur content of less than 5 wt. %. The hard carbon may have a nitrogen content of less than 5 wt. %. The hard carbon may have an oxygen content of less than 10 wt. %.

According to a further embodiment of the present disclosure there is a sodium-ion battery comprising an anode formed from hard carbon produced by the method of claim 1.

Other aspects and features of the present disclosure will become apparent to those ordinarily skilled in the art upon review of the following description of specific embodiments in conjunction with the accompanying figures.

### BRIEF DESCRIPTION OF THE DRAWINGS

The accompanying drawings constitute part of the disclosure. Each drawing illustrates exemplary aspects wherein similar characters of reference denote corresponding parts in each view,

FIG. 1 are images of the raw asphaltene (a-d) and acid treated asphaltene at initial pre-carbonized and carbonized condition in particular a) raw asphaltene, b) after thermal oxidation, c) after carbonization, d) acid treated asphaltene, e) after acid treatment followed by thermal oxidation step, f) after carbonization of sample e).

FIG. 2 are charts of XRD and FTIR spectra of raw asphaltene and acid treated asphaltene before and after thermal oxidation at 350° C. under an oxygen-rich atmosphere.

FIG. 3 illustrate CHNSO analysis of raw and acid treated asphaltene before and after 350° C. under thermal oxidation.

FIG. 4 are illustrations of XPS spectra of raw and acid treated asphaltene before and after thermal oxidation at 350° C. in an oxygen-rich atmosphere: (a) C 1s, (b) O 1s, (c) S 2p, and (d) N 1s scans.

FIG. 5 are graphs of X-ray diffraction and Raman spectra of hard carbon synthesized from acid treated asphaltene at different temperature under argon atm.

FIG. 6 are graphs of X-ray diffraction and Raman spectra of hard carbon synthesized from Raw asphaltene at elevated temperature under an inert gas atm.

FIG. 7 are illustrated calculated d-spacing, and ID/IG ratio of raw and HNO3-treated asphaltene derived hard carbon at different temperatures.

FIG. 8 is a CHNSO analysis of RASP-HC and HN-ASP-HC at different temperatures under an inert gas atm.

FIG. 9 are images of High resolution TEM images and SAED patterns of HN-ASP-HC materials synthesized at different temperatures.

FIG. 10 are images of SEM images of HN-ASP-HC materials synthesized at different temperatures.

FIG. 11 are SEM and TEM images of RASP-HC-1500 material.

FIG. 12 is a Charge-discharge performances of HN-ASP-HC anodes cycled 2 to 0.005 V cut-off voltage in the half-cell configuration (HN-ASP-HC|100 μL of 1 M NaPF6 in diglyme Na metal). a) First charge-discharge profile comparison of HN-ASP-HC anodes at 0.1 C, b) Initial Coulombic efficiency values in the first cycle, c) Cycling performance of HN-ASP-HC anodes at 0.1 C, d) Rate capability of HN-ASP-HC anodes at different current rates, and e) High-rate cycling of the HN-ASP-HC-1500 anode at 1 C (theoretical capacity of HC: 300 mAh·g⁻¹).

FIG. 13 are 1st and 3rd cycle CV curves comparison of HN-ASP-HC anodes tested in the potential range of 2 to 0.005 V at 0.05 mV s-1

FIG. 14 are illustrations of slope and plateau capacity distribution during the 1st and 50th discharge-charge of HN-ASP-HC anodes in the half-cell configuration

FIG. 15 are illustrations of electrochemical performance of the RASP-HC-1500 anode in the half-cell configuration: (a) First charge-discharge profile at 0.1 C and (b) cycling performance at 1 C over 100 cycles.

FIG. 16 are Nyquist plots of RASP-HC-1500 and HN-ASP-HC-1500 anodes before and after the 300th discharge at 1 C.

FIG. 17 are Cyclic voltammetry (CV) curves of RASP-HC-1500 and HN-ASP-HC-1500 anodes recorded within a potential range of 2.0-0.005 V at scan rates of 0.05, 0.1, 0.2, 0.3, 0.4, and 0.5 mV s⁻¹. (c, d) Log (sweep rate) vs. log (peak current) plots for b-value determination. (e, f) Contribution analysis of capacitive and diffusion-controlled charge storage in RASP-HC-1500 and HN-ASP-HC-1500 anodes using Dunn's method.

FIG. 18 Relationship between peak currents and sweep rates for (a) RASP-HC-1500 and (b) HN-ASP-HC-1500 anodes

FIG. 19 are Ex-situ XRD, (c-d) ex-situ XPS comparison of RASP-HC-1500 and HN-ASP-HC-1500 anode surface at different charging conditions under 0.1 C in the half-cell configuration

FIG. 20 are a) First-cycle charge-discharge profiles of HN-ASP-HC anode, and Na₃V₂(PO₄)₃ cathode in a half-cell configuration at 0.1 C, b) Initial charge-discharge profile of the full cell in the configuration of HN-ASP-HC-1500|100 μL of 1 M NaPF₆ in diglyme|Na₃V₂(PO₄)₃ at 0.1 C with the different N/P ratios, and c) High-rate cycling of the full cell at 1 C with the different N/P ratios

### DETAILED DESCRIPTION

Referring to the attached figures, an exemplary method for Converting polycyclic aromatic hydrocarbons from bitumen into hard carbon for energy storage applications is disclosed herein. Hard carbon (HC) anode materials are promising candidates for sodium-ion batteries (SIBs) due to their abundant resources, low cost, and excellent electrochemical properties. Asphaltenes, a carbon-rich poly-aromatic hydrocarbon (PAH) byproduct of bitumen, contain up to 80-90 wt. % carbon, making them an ideal precursor for hard carbon production. The presence of heteroatoms like sulfur and nitrogen in asphaltenes can further enhance sodium storage. As disclosed herein hard carbon derived from asphaltene is synthesized through a two-step carbonization process. Initially, asphaltene was pre-carbonized in an oxygen-rich atmosphere and then carbonized under an inert gas, such as, by way of non-limiting example, argon or nitrogen, at various temperatures. Treatment with an oxidizing agent or chemical, such as, by way of non-limiting example, nitric acid (HNO3), sulfuric acid, phosphoric acid or hydrogen peroxide, of asphaltene during pre-carbonization led to C═O, and C—N crosslinking in the carbon structure, producing a more disordered carbon structure with larger interlayer spacing (~0.38 nm), compared to the raw asphaltene-derived carbon (~0.35 nm). Oxidizing agent treated asphaltene derived hard carbon (HN-AS-HC) at 1500° C. shown the low voltage charge plateau capacity value of 200 mAh·g⁻¹ with the initial Coulombic efficiency (I.C.E.) values of 85% at 0.1 C. In contrast, raw asphaltene-derived hard carbon at the same conditions possesses the charge plateau capacity of 26 mAh·g⁻¹ with I.C.E. value of 74.8%. The oxygen functional groups introduced during pre-carbonization possibly enhanced the interlayer spacing and defects after carbonization, improving the electrochemical performance of the asphaltene-derived hard carbon. The present disclosure demonstrates the potential of oxidizing agent-pretreated asphaltene-derived hard carbon as a promising anode material for practical sodium-ion battery applications.

By way of non-limiting example, 8 g of asphaltenes are washed (stirred) with 50% HNO3 (400 mL) for 1 h, filtered, washed with water until gets neutral pH, and dried under vacuum at 100° C. for 12 h. The pre-treated asphaltene precursors are treated for the multi-step pre-carbonization under an oxygen-rich atmosphere, such as by way of non-limiting example, air, although it will be appreciated that pure oxygen, ozone or other oxygen rich atmospheres may also be useful as well. By way of non-limiting example, 5 g of asphaltene is heated from ambient temperature to 260° C. with a slow heating rate, such as, by way of non-limiting example, 1° C./min, and it dwelled at 260° C. for 4 h. Next, the temperature is ramped up from 260° C. to a temperature in the range of 350° C. to 800° C. at a heating rate, such as, by way of non-limiting example, 5° C./min, and maintained for 2 h. The pre-carbonized asphaltenes are ball-milled, such as, by way of non-limiting example, at 750 rpm for 15 min. The ball-milled asphaltene fine powders (such as, by way of non-limiting example, 0.4 g) are then carbonized at different temperatures (such as, by way of non-limiting example, from 1200-1800° C.) under an inert gas (flow rate, such as, by way of non-limiting example: 120 Sccm) at a heating rate, such as, by way of non-limiting example, in the range of 0.5° C./min to 10° C./min, for a period of time selected to be, by way of non-limiting example, between 5 minutes and 5 hours. The synthesized HC materials are denoted as HN-ASP-HC-1200, HN-ASP-HC-1300, HN-ASP-HC-1400, HN-ASP-HC-1500, and HN-ASP-HC-1600, respectively.

The same heating and ball-milling treatments are followed to prepare hard carbon from the non-acid treated asphaltene (raw asphaltene), and the HCs are denoted as RASP-HC-1200, RASP-HC-1300, RASP-HC-1400, RASP-HC-1500, and RASP-HC-1600.

All electrochemical experiments were conducted using CR2032-type coin cells assembled in an argon-filled glove box. By way of non-limiting example, the hard carbon anode consisted of 80 wt. % hard carbon (asphaltene-derived hard carbon), 10 wt. % Super P conductive carbon, and 10 wt. % CMC binder. A homogeneous slurry was prepared using an appropriate amount of Millipore water and coated onto copper foil. The coated electrodes were dried under vacuum at, by way of non-limiting example, 100° C. for 12 hours and calendered at 70° C. using a TMAX hot roll press. The electrode thickness was maintained in the range of, by way of non-limiting example, 60-70 μm, with the coated hard carbon content being, by way of non-limiting example, 1.2-2.0 mg cm⁻². The Na₃V₂(PO₄)₃ cathode electrode consisted of, by way of non-limiting example, 80 wt. % Na₃V₂(PO₄)₃, 10 wt. % Super P conductive carbon, and 10 wt. % PVDF binder. A homogeneous slurry was prepared using an appropriate amount of NMP, coated onto aluminum foil, and dried under vacuum at, by way of non-limiting example, 120° C. for 12 hours and calendered at 70° C. For both the anode and cathode, the electrodes were punched into circular discs with a diameter of, by way of non-limiting example, 14 mm for all experiments. Whatman GF/D glass fiber filter paper with a diameter of, by way of non-limiting example, 20 mm was used as the separator. The electrolyte used was, by way of non-limiting example, 100 μL of 1 M NaPF₆ in diglyme. The half-cell configuration used in the experiments consisted of hard carbon|1 M NaPF₆ in diglyme|sodium metal. For the full-cell configuration, hard carbon (anode) and Na₃V₂(PO₄)₃ (cathode) were used, with the cell configuration being hard carbon|1 M NaPF₆ in diglyme|Na₃V₂(PO₄)₃.

As utilized herein, the raw asphaltene waste, HNO₃ (ACS reagent, 70%), diglyme (diethylene glycol dimethyl ether), N-methyl pyrrolidone (NMP), GF/D Whatman glass microfiber filters, commercial hard carbon anode, Na₃V₂(PO₄)₃ cathode and polyvinylidene fluoride (PVDF) materials may be sourced from any available source.

### Raw and HNO₃ Treated Asphaltenes

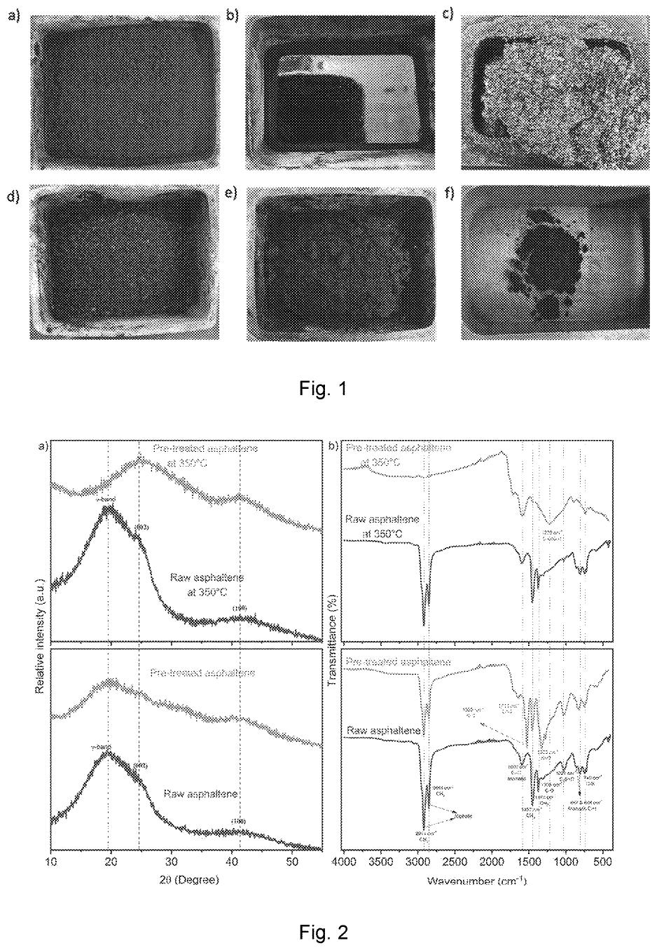

FIG. 1 shows the digital images of raw and acid-treated asphaltenes under various heating conditions. The color of the raw asphaltene transitions from brown to black after acid treatment (FIG. 1a, d). The material loss after the HNO₃ treatment is approximately 5-7 wt. %, resulting in a yield of 93-95 wt. % at the end of the drying process. During the pre- and post-carbonization processes, the raw asphaltene undergoes melting and forms a highly viscous substance (FIG. 1b, c), posing challenges in its collection from the crucibles. FIG. 1e-f represents the images of pre- and post-carbonized acid-washed asphaltenes. Notably, these asphaltenes do not undergo melting after being subjected to carbonization conditions. This final product is non-sticky and facilitates easy collection from the crucible. The yield percentages of raw and acid-washed asphaltenes after pre-carbonization, which are 98% and 70% respectively, are detailed in Table 1.

TABLE 1
Yield percentages of raw and acid-Washed
asphaltene before and after 350 °C

| | | Before | After | |
|---|---|---|---|---|
| | Heating | heating | heating | Yield |
| Compound | atmosphere | (g) | (g) | (%) |
| Raw asphaltene | Air | 5 | 4.90 | 98.00 |
| HNO₃ treated | Air | 5 | 3.5 | 70.00 |
| asphaltene | | | | |

The physical changes in raw and pre-treated asphaltene before and after pre-carbonization were characterized using XRD, FT-IR, CHNS, and XPS spectroscopy. FIG. 2a shows the XRD patterns of raw and acid-washed asphaltene before and after heating at 350° C. in an oxygen-rich atmosphere. The raw asphaltene exhibits three distinct peaks at 19.36°, 23.93°, and 41.06°, corresponding to the γ-band and the (002) and (100) graphitic planes, respectively. The presence of the γ-band indicates aliphatic alkyl groups in the side chains. Acid treatment does not significantly alter the XRD pattern, as the peaks remain unchanged, suggesting the structural integrity of asphaltene is preserved. Upon heating at 350° C., the XRD pattern of raw asphaltene retains these peaks. In contrast, the γ-band disappears in the pre-treated asphaltene after heating at 350° C., while the other peaks persist. The disappearance of the γ-band implies the removal of aliphatic side chains or crosslinking of oxygen functionalities within these chains.

FIG. 2b shows the FT-IR spectra of raw and pre-treated asphaltene before and after heating at 350° C. Before heat treatment, raw asphaltenes shows the peaks at 2853 and 2914 cm⁻¹ corresponding to aliphatic CH₂ and CH₃ groups. Aromatic peaks at 1600, 1457, 1370, 1308, 857, and 806 cm⁻¹ correspond to C═C, CH₃, CH₂, C—O, and C—H bonds. Peaks at 1021 and 740 cm⁻¹ indicate the presence of C—S and C═S═O groups. The pre-treated asphaltenes exhibit similar peaks and show the appearance of additional peaks at 1713, 1520, and 1325 cm⁻¹, indicating the crosslinking of C═O, N—O, and S═O. Pre-carbonized acid-treated asphaltene shows the disappearance of peaks at 2853, 2914, 1457, 1350, 1108, and 1500 cm⁻¹, indicating the removal of aliphatic-aromatic CH₃, CH₂, C—O and N—O. Additionally, a broad peak emerged at 1230 cm⁻¹, corresponding to C—O/C—N, suggesting the formation of oxygen and nitrogen-functionalized crosslinks. These pre-oxidation processes likely contribute to the disordering of the carbon structure at elevated temperatures.

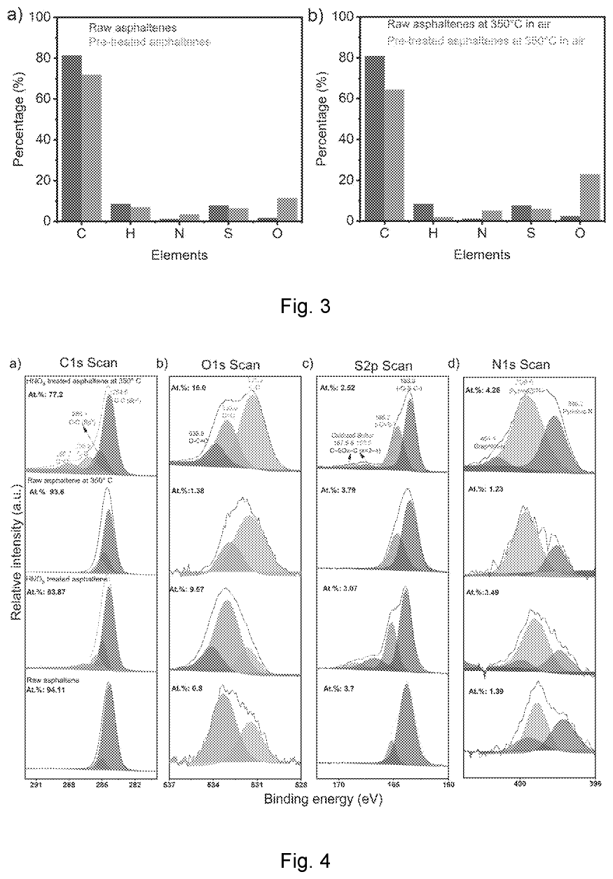

The elemental composition of asphaltenes before and after heating was analyzed using CHNS analysis, as illustrated in FIG. 3 a-b, with detailed values presented in Table 2.

TABLE 2
CHNSO percentage values obtained from raw and pre-treated
asphaltene before and after 350 °C under air

| Compound | C-% | H-% | N-% | S-% | O-% |
|---|---|---|---|---|---|
| Raw asphaltene | 81.28 | 8.39 | 1.05 | 7.66 | 1.62 |
| Acid treated asphaltene | 71.86 | 6.95 | 3.38 | 6.32 | 11.49 |
| Raw asphaltene at 350 °C | 80.89 | 8.25 | 1.07 | 7.44 | 2.35 |
| Acid treated asphaltene at 350 °C | 64.37 | 1.95 | 4.92 | 5.89 | 22.87 |

FIG. 3 a-b compares the CHNSO percentages of raw and pre-treated asphaltenes, where the oxygen content is determined by subtracting the total CHNS percentage from 100. Raw asphaltene exhibits an elemental composition of 81.28 wt. % carbon, 8.39 wt. % hydrogen, 1.05 wt. % nitrogen, 7.66 wt. % sulfur, and 1.62 wt. % oxygen. Significant compositional changes are observed after pre-treatment with HNO₃, attributed to the functionalization of nitrogen and crosslinking of oxygen during the acid treatment. This pre-treatment reduces carbon, hydrogen, and sulfur contents to 71.86 wt. %, 6.95 wt. %, and 6.32 wt. %, respectively, while increasing nitrogen and oxygen contents to 3.38 wt. % and 11.49 wt. %, respectively. Upon pre-oxidation, raw asphaltenes show only minimal changes in composition, with oxygen content increasing slightly from 1.62 to 2.35 wt. %. In contrast, pre-treated asphaltenes display a much stronger response to pre-oxidation. The oxygen content significantly increases from 11.49 to 22.87 wt. %, accompanied by decreases in carbon (64.37 wt. %), hydrogen (1.95 wt. %), and sulfur (5.89 wt. %). Furthermore, nitrogen content increases from 3.38 to 4.92 wt. %. CHNS analysis suggests that pre-oxidation is significantly more effective for pre-treated asphaltenes compared to raw asphaltenes, underlining the role of HNO₃ treatment in improving their oxidative reactivity.

FIG. 4 a-d presents the high-resolution XPS scans of C1s, O1s, S2p, and N1s for raw and HNO₃-treated asphaltenes before and after heating at 350° C. The C1s scan (FIG. 4a) for raw asphaltene shows peaks at 284.5, 285.1, and 286.2 eV, corresponding to C—C(sp²), C—C(sp³), and C—O bonds, respectively. These peaks remain after heating at 350° C. under an oxygen-rich atmosphere, with no significant change in the atomic percentage of carbon. The HNO₃-treated sample exhibits an additional peak at ~288.7 eV, assigned to O—C═O bonds. Heating enhances the concentration of C—O and O—C═O bonds, reducing the carbon atomic percentage from 83.87% to 77.2%, as shown in FIG. 4a. The O1s scan (FIG. 4b) shows an increase in oxygen functionalities in the HNO₃-treated sample (at. %: 9.57%), which further rises after heating (at. %: 16.0%). It shows the two common peaks at 531.3 and 533.3 eV correspond to C═O and C—O bonds, respectively. The pretreatment initiates the formation of O—C═O, identified from the presence of an additional peak at 533.8 eV, which becomes more pronounced after heating. The S2p scan is shown in FIG. 4c, displaying the common peaks at 163.9, and 165.2 eV due to the presence of —C—S—C—, and —C═S— bonds. Some of the sulfur species undergoes oxidation for HNO₃ treated samples, which is clearly indicated from the appearance of peaks at 168.8, and 167.5 eV. The obtained peaks are getting reduced after heating which leads to the atomic percentage values of sulfur from 3.07 to 2.52%. Notably, the sulfur content in raw asphaltene remains stable at approximately 3.7% before and after heating. The N1s spectra (FIG. 4d) shows peaks at 398.2, 399.6, and 401.1 eV, associated with pyridinic, pyrrolic, and graphitic nitrogen, respectively. The nitrogen concentration is higher in HNO₃-treated asphaltene due to functionalization during pretreatment, with a nitrogen atomic percentage of 4.28% in the pre-oxidized sample, indicating the incorporation of nitrogen species during the treatment process.

### Asphaltenes Derived Hard Carbon at Different Temperature

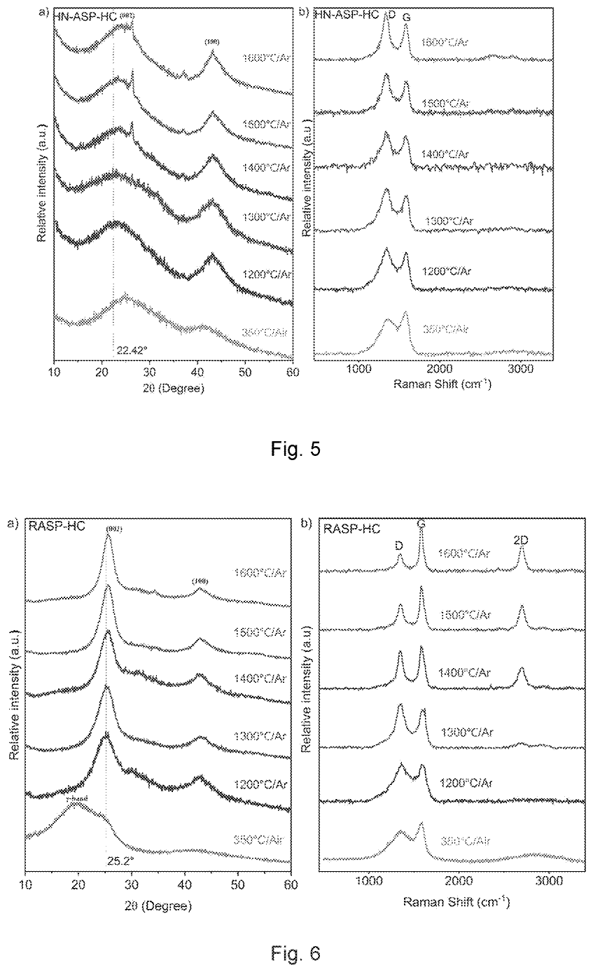

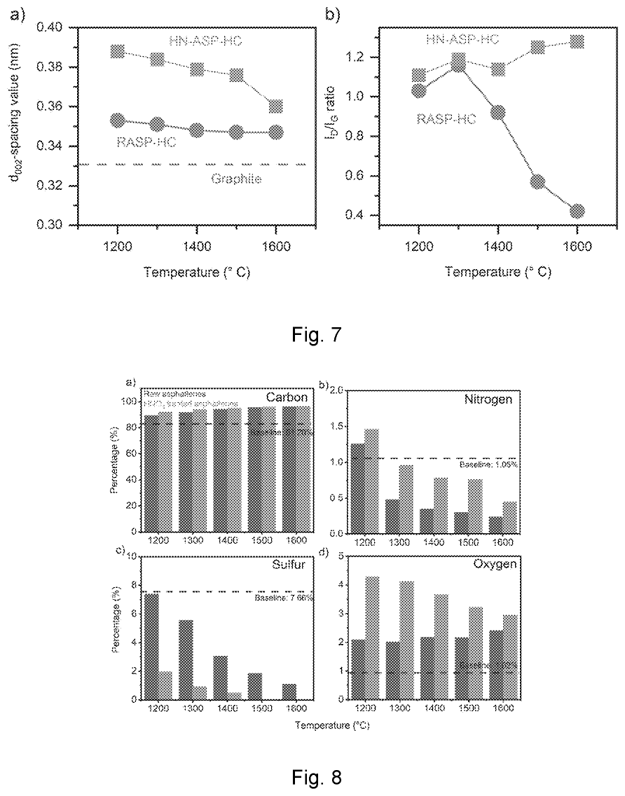

Hard carbon was synthesized from raw and pre-treated asphaltene, carbonized at temperatures ranging from, by way of non-limiting example, 1200 to 1800° C. in an inert gas atmosphere for, by way of non-limiting example, a period of time selected to be between 5 minutes and 5 hours at a heating rate of, by way of non-limiting example, in the range of 0.5° C./min to 10° C./min. The XRD patterns of the synthesized hard carbon from the asphaltene precursors are shown in FIGS. 5a and 6a. All patterns display two broad peaks at 23-25° and 40-43°, corresponding to the (002) and (100) graphitic planes, respectively. The broadness of these peaks indicates that the synthesized hard carbons are amorphous and disordered. The d-spacing value of the hard carbon was calculated from the (002) plane using Bragg's equation. The (002) peak value of raw asphaltene-derived carbon (RASP-HC) ranges from 25.0 to 25.65°, while that of HNO₃ treated asphaltene-derived carbon (HN-ASP-HC) lies between 22.4 and 25.0° across different temperatures. The peaks of RASP-HC are sharper, and a peak at 26.3° appears in the HN-ASP-HC patterns with increasing temperature, indicating the growth of graphitization (FIGS. 5a and 6a). The d-spacing is a critical parameter for sodium storage during cycling, with reports suggesting that a value between 0.37 and 0.4 nm is beneficial. The calculated d-spacing values for asphaltene-derived hard carbon, using Bragg's equation, are presented in Table 3, and FIG. 7a.

TABLE 3
d-spacing, I_{D}/I_{G}, and I_{2D}/I_{G} ratio value of raw and HNO₃-
treated asphaltene derived hard carbon at different temperatures

| | d-spacing (nm) | | I_{D}/I_{G} ratio | | I_{2D}/I_{G} ratio | |
|---|---|---|---|---|---|---|
| | | HN- | | HN- | | HN- |
| Temperature | RASP- | ASP- | RASP- | ASP- | RASP- | ASP- |
| (°C) | HC | HC | HC | HC | HC | HC |
| 350 | 0.353 | 0.356 | 0.76 | 0.81 | — | — |
| 1200 | 0.353 | 0.388 | 1.03 | 1.11 | — | — |
| 1300 | 0.351 | 0.384 | 1.16 | 1.19 | — | — |
| 1400 | 0.348 | 0.379 | 0.92 | 1.14 | — | 0.50 |
| 1500 | 0.347 | 0.376 | 0.57 | 1.25 | — | 0.57 |
| 1600 | 0.347 | 0.36 | 0.42 | 1.28 | — | 0.61 |

For raw asphaltene carbonized at 1200° C., the d-spacing is 0.355 nm, a value maintained up to 1300° C., after gradually decreases, reaching 0.347 nm at 1600° C. These values are close to the d-spacing of graphite (0.335 nm). In contrast, the d-spacing of HN-ASP-HC at 1200° C. is 0.388 nm. This value gradually decreases with increasing temperature, resulting in d-spacing values of 0.384, 0.379, 0.376, and 0.360 nm at 1300° C., 1400° C., 1500° C., and 1600° C., respectively. The obtained d-spacing values are greater than the RASP-HCs, also indicating their suitability for sodium ion accommodation.

The Raman spectra of hard carbon synthesized from raw and HNO₃-treated asphaltene at different temperatures are shown in FIGS. 5b and 6b. The spectra exhibit two characteristic peaks at 1350 cm-1 and 1580 cm⁻¹, corresponding to the D-band (sp³ hybridization) and G-band (sp² hybridization). Raw asphaltenes retained all the peaks when increasing the temperature, while pre-treated asphaltene shows the appearance of an extra peak at 2800 cm⁻¹ when heating at 1400-1600° C. This peak is not associated with defects but rather correlates with the growth of the number of layers in the carbon matrix. The calculated ID/IG ratios for RASP-HC and HN-ASP-HC are illustrated in Table S3, and FIG. 7b, with respect to the different temperatures. The calculated ID/IG ratio of raw asphaltene from 350, 1200, 1300, 1400, 1500, and 1600° C. are 0.76, 1.03, 1.16, 0.92, 0.57, and 0.42, respectively. The obtained values are decreased when increasing temperature due to the growth of graphitization. In contrast, the ID/IG ratios for HNO₃-treated asphaltene-derived carbon were 0.81, 1.11, 1.19, 1.14, 1.25, and 1.28 at the corresponding temperatures. The increasing I_{D}/I_{G} values with the temperature can be related to the growth of defects in the carbon structure. The rise in the structural defects, likely due to the introduction of oxygen-containing functional groups during the pre-treatment and pre-oxidation processes, which disrupts the graphitic framework upon heating. Additionally, the calculated I_{2D}/I_{G} ratio of HN-ASP-HC at 1400, 1500, and 1600° C. is 0.50, 0.57, and 0.61 improved multi layers formation within the carbon structure.

### Results and Discussion

CHNSO analysis of the synthesized hard carbon from asphaltenes at different temperatures is displayed in FIG. 8(a-d) and Table 4.

TABLE 4
CHNSO values of RASP-HC and HN-ASP-HC at different temperatures under argon atm.

| | C (%) | | H (%) | | N (%) | | S (%) | | O (%) | |
|---|---|---|---|---|---|---|---|---|---|---|
| Temperature | | HNO₃ | | HNO₃ | | HNO₃ | | HNO₃ | | HNO₃ |
| (°C) | Raw | treated | Raw | treated | Raw | treated | Raw | treated | Raw | treated |
| 1200 | 89.26 | 92.28 | 0 | 0 | 1.26 | 1.46 | 7.39 | 1.97 | 2.09 | 4.29 |
| 1300 | 91.93 | 93.98 | 0 | 0 | 0.48 | 0.96 | 5.57 | 0.93 | 2.02 | 4.13 |
| 1400 | 94.41 | 95.07 | 0 | 0 | 0.35 | 0.78 | 3.06 | 0.49 | 2.18 | 3.66 |
| 1500 | 95.68 | 96.02 | 0 | 0 | 0.3 | 0.76 | 1.85 | 0 | 2.17 | 3.22 |
| 1600 | 96.26 | 96.59 | 0 | 0 | 0.24 | 0.45 | 1.09 | 0 | 2.41 | 2.96 |

The carbon content of RASP-HC and HN-ASP-HC, shown in FIG. 8a, increases with temperature, reaching 91.26% and 96.59%, respectively, at 1600° C., compared to the baseline value of 81.28%. The hydrogen content is completely removed at higher temperatures (1200-1600° C.), as shown in Table 4. The nitrogen, sulfur, and oxygen contents decrease with increasing temperature, exhibiting a similar trend for both raw and HNO₃-treated asphaltenes (FIG. 2c-d and Table 4). Additionally, HNO₃-treated asphaltenes at 1500-1600° C. is not showing sulfur content, whereas in the raw material, it remains at nearly 1.0-1.85%.

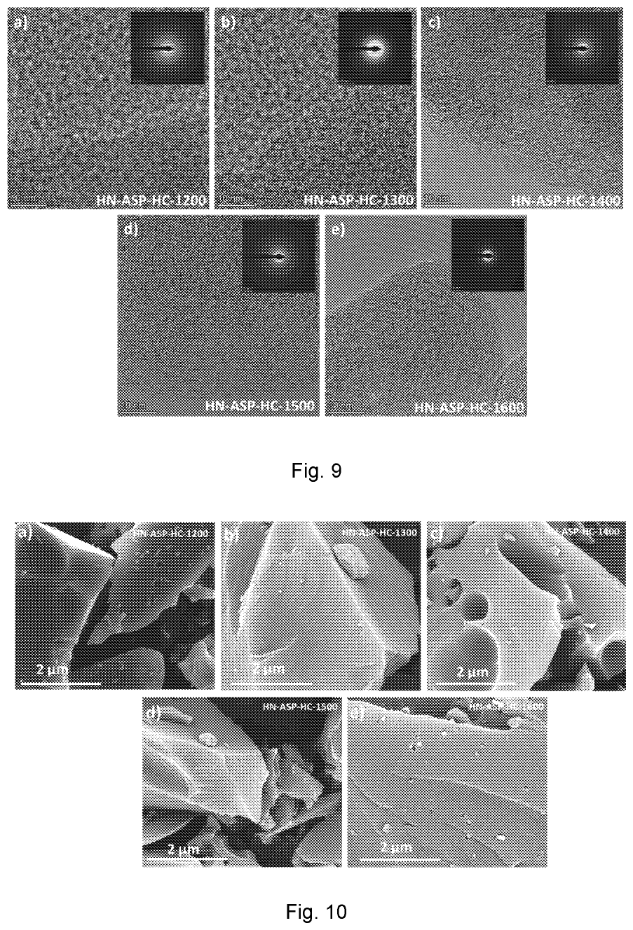

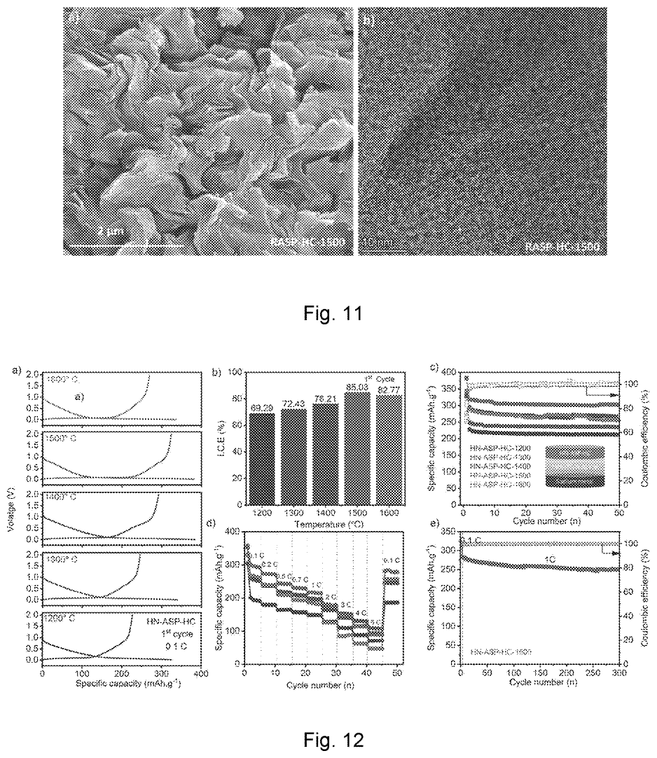

The morphology of the hard carbons was characterized by using Scanning electron microscopy (SEM) and Transmission electron microscopy (TEM) and the obtained images are illustrated in FIG. 10 a-e. SEM images of HN-ASP-HC materials synthesized materials indicating the appearance of sheets like morphology. For comparison, SEM image of RASP-HC-1500 is shown in FIG. 11a, also exhibiting the stacked graphene like sheets morphology. Additionally, a TEM image of RASP-HC-1500 demonstrates the well-orderly arranged graphite like structure FIG. 11b. TEM images of HN-ASP-HC at different temperatures are shown in FIG. 9(a-e), reveals that the irregular arrangement of carbon layer when increasing the carbonization temperature. Further, the obtained ring type of selected area electron diffraction (SAED) patterns, indicating the amorphous characteristics of the synthesized hard carbon materials.

### Half-Cell Performances of Asphaltenes Derived Hard Carbon Anode in SIBs

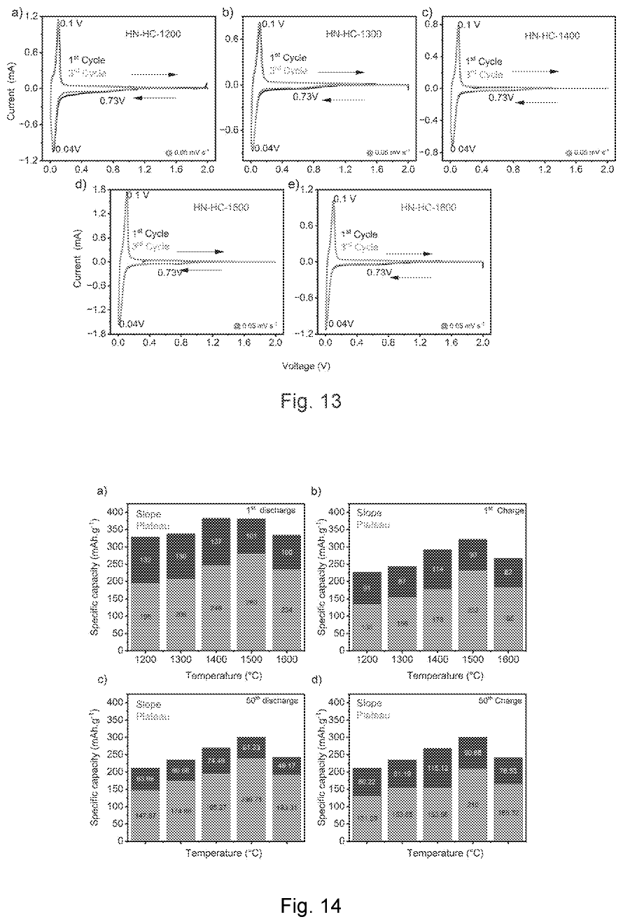

The cyclic voltammogram (CV) of HN-ASP-HC anodes was recorded in the potential range of 2.0 to 0.005 V at a scan rate of 0.05 mV·s⁻¹, and the first and third CV curves are compared in FIG. 13(a-e). A broad irreversible peak observed at 0.73 V in the cathodic region corresponds to the formation of the solid electrolyte interphase (SEI) layer due to electrolyte decomposition. The reduction peak at 0.01 V and the oxidation peak at 0.1 V are attributed to the insertion and de-insertion of sodium ions, respectively. All HN-ASP-HC anodes exhibit similar insertion/de-insertion peak positions and intensities in the third cycle compared to initial cycle, indicating stable electrochemical behavior. The initial charge-discharge profiles of HN-ASP-HC anodes synthesized at different temperatures at a 0.1 C rate in the voltage range of 2 to 0.005 V, are presented in FIG. 12a, while the corresponding initial Coulombic efficiency (I.C.E.) values are summarized in FIG. 12b. The specific discharge capacity of the anodes ranges from 330 to 385 mAh g⁻¹ during the formation cycle, as detailed in Table 5.

TABLE 5
Capacity values of HN-ASP-HC anodes at 0.1 C in the half-cell configuration.

| | 1^{st} cycle | | | 2^{nd} cycle | | | 50^{th} cycle | | |
|---|---|---|---|---|---|---|---|---|---|
| | Charge | Discharge | | Charge | Discharge | | Charge | Discharge | |
| | capacity | capacity | C.E. | capacity | capacity | C.E. | capacity | capacity | C.E. |
| Anode Material | (mAh · g⁻¹) | (mAh · g⁻¹) | (%) | (mAh · g⁻¹) | (mAh · g⁻¹) | (%) | (mAh · g⁻¹) | (mAh · g⁻¹) | (%) |
| HN-ASP-1200 | 226.85 | 327.35 | 69.29 | 221.21 | 227.79 | 97.10 | 212.45 | 212.69 | 99.888 |
| HN-ASP-1300 | 245.40 | 338.79 | 72.43 | 242.32 | 248.64 | 97.45 | 234.78 | 235.09 | 99.86 |
| HN-ASP-1400 | 292.21 | 383.40 | 76.21 | 285.27 | 294.68 | 96.80 | 259.14 | 258.53 | 100.2 |
| HN-ASP-1500 | 323.26 | 380.14 | 85.03 | 315.46 | 317.70 | 99.29 | 301.71 | 302.22 | 99.83 |
| HN-ASP-1600 | 285.49 | 344.89 | 82.77 | 265.74 | 273.61 | 97.12 | 241.94 | 242.63 | 99.71 |

Notably, the capacity of HN-ASP-HC anodes increases with synthesis temperature. Specifically, the charge capacities of HN-ASP-HC-1200, HN-ASP-HC-1300, HN-ASP-HC-1400, HN-ASP-HC-1500, and HN-ASP-HC-1600 are 226, 245, 292, 323, and 285 mAh g⁻¹, respectively. The corresponding I.C.E. values for these anodes are 67.7, 72.8, 76.0, 85.03, and 80.2%, respectively. The increase in I.C.E. and charge capacity with rising synthesis temperatures could be attributed to the formation of closed pores or ultra micropores due to crosslinked oxygen functionalities which improved Na⁺ active sites, and the reduction in surface area. This structural evolution minimizes electrolyte decomposition, thereby suppressing excessive SEI layer formation. However, HN-ASP-HC-1600 showed a decline in capacity value and I.C.E. is observed compared to HN-ASP-HC-1500, which can be correlated with the reduced interlayer spacing of HN-ASP-HC-1600 (0.36 nm) and HN-ASP-HC-1500 (0.376 nm). The low interlayer spacing minimizes the availability of Na⁺ active reaction sites, leading to lower sodium storage capacity and decreased I.C.E. in the formation cycle than HN-ASP-HC-1500 anode. After the formation cycle, the capacity values are maintained in the subsequent cycles and it delivers 212, 235, 258, 302, and 242 mAh·g⁻¹ in the 50th cycle, corresponding to HN-ASP-HC-1200, HN-ASP-HC-1300, HN-ASP-HC-1400, HN-ASP-HC-1500, and HN-ASP-HC-1600, respectively (FIG. 12c and Table 5).

The slope and plateau capacity contributions of HN-ASP-HC anodes with respect to synthesis temperature during formation and the 50th cycle at 0.1 C are illustrated in FIG. 14 a-d. The plateau capacity values are prominent occurring below 0.17 V, which is diffusion-dominated, while the slope capacities occur at higher voltages (0.17 to 2.0 V) and are dominated by Na⁺ ion adsorption/desorption. The slope capacity values are highly reversible; however, it limits the energy density of sodium-ion batteries. Here, the HN-ASP-HC-1500 anode exhibited a higher plateau capacity and lower slope capacity than the other anodes. It exhibits a plateau capacity of 280 and 230 mAh·g⁻¹ at the 1^{st} discharge and charge, respectively, with values reaching 239 and 210 mAh·g⁻¹ in the 50th cycle (FIG. 14 a-d). It possesses a plateau capacity retention of 85.4% and 90.5% at the 50th discharge and charge, respectively. Besides, the slope capacity of the HN-ASP-HC-1500 anode exhibits 101 mAh·g⁻¹ at the initial discharge, decreasing to 61.23 mAh·g⁻¹ at the 50th discharge. It showed a slope capacity retention of only 60.3%, with a difference of 40 mAh·g⁻¹ at the 50th discharge compared to the initial discharge. The irreversible decomposition of the electrolyte during SEI layer formation in the slope region at the first discharge limits retention in the 50th discharge. However, the slope capacity during the charge process exhibited 100% retention at the 50^{th} charge, as clearly depicted in FIG. 14b,d.

The rate capability of HN-ASP-HC anodes was evaluated at various current rates (0.1, 0.2, 0.5, 0.7, 1, 2, 3, 4, and 5 C), as illustrated in FIG. 12d, with corresponding values presented in Table 6.

TABLE 6
Capacity values (after the formation cycle) of HN-ASP-HC anodes
at different current condition in the half-cell configuration

| | | | | | | | | | | Retained |
|---|---|---|---|---|---|---|---|---|---|---|
| | | | | | | | | | | capacity value |
| | | | | | | | | | | (mAh · g⁻¹) |
| | | | | | | | | | | at 0.1 C |
| | Capacity value (in mAh · g⁻¹) at | | | | | | | | | after high |
| Anode Material | 0.1 C | 0.2 C | 0.5 C | 0.7 C | 1 C | 2 C | 3 C | 4 C | 5 C | rates |
| HN-ASP-1200 | 202 | 180 | 164 | 158 | 148 | 129 | 110 | 90 | 71.2 | 187 |
| HN-ASP-1300 | 257 | 237 | 218 | 210 | 200 | 174 | 155 | 132 | 112 | 249 |
| HN-ASP-1400 | 260 | 239 | 218 | 211 | 196 | 166 | 140 | 115 | 94 | 247 |
| HN-ASP-1500 | 302 | 274 | 244 | 230 | 218 | 182 | 147 | 116 | 90 | 283 |
| HN-ASP-1600 | 268 | 241 | 210 | 195 | 186 | 124 | 88 | 65 | 48 | 255 |

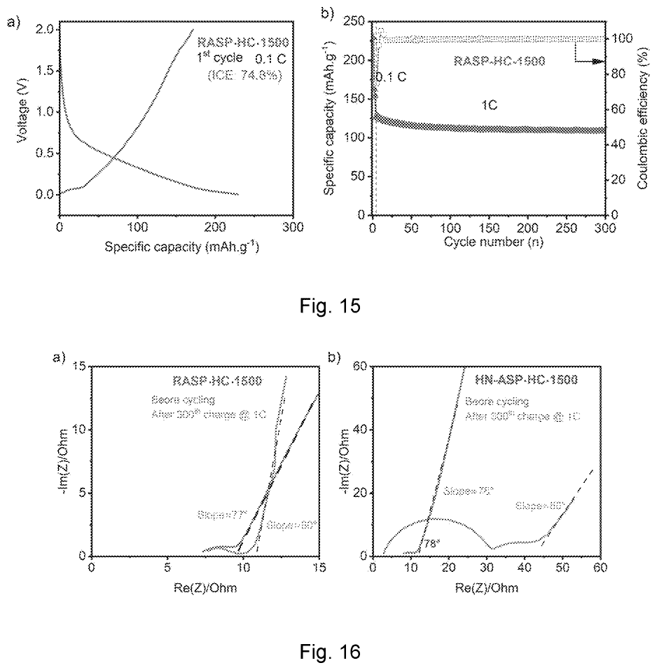

Among the tested anodes, HN-ASP-1500 exhibited superior performance at lower current rates (0.1 C to 3 C) compared to the other anodes, delivering capacities of 302, 274, 244, 230, 218, 182, and 147 mAh·g⁻¹ at 0.1, 0.2, 0.5, 0.7, 1, 2, and 3 C, respectively. At higher current rates (4 C and 5 C), the capacity retention of HN-ASP-1500 was lower than that of the HN-ASP-1300 anode. A similar trend was observed for the HN-ASP-1400 and HN-ASP-1600 anodes, which also demonstrated reduced capacity at elevated current densities. This behavior is attributed to the decline in capacitive storage sites as the synthesis temperature increases, thereby influencing high-rate performance. To further assess the electrochemical stability, the HN-ASP-1500 anode was subjected to high-rate cycling at 1 C after stabilizing the cell at 0.1 C for three cycles (FIG. 12e). The anode exhibited an initial capacity of 310 mAh·g⁻¹ after the formation cycle at 0.1 C, with an initial Coulombic efficiency (I.C.E.) of 85%. After the stabilization cycles, the anode delivered a capacity of 268 mAh·g⁻¹ at 1 C, maintaining stable cycling performance and achieving 245 mAh·g⁻¹ at the 300^{th} cycle, corresponding to a capacity retention of 91.4%. Furthermore, the electrochemical performance of the HN-ASP-HC-1500 anode has been compared with that of the raw asphaltene-derived hard carbon anode synthesized at 1500° C. (RASP-HC-1500), as shown in FIG. 15 a-b. The RASP-HC-1500 anode exhibits a discharge capacity of 229 mAh·g⁻¹ and a corresponding charge capacity of 172 mAh·g⁻¹, with an initial coulombic efficiency (I.C.E.) of 74.8% at a 0.1 C rate. The corresponding charge-discharge profile depicted in FIG. 15a exhibits the sodium storage mechanism governed by the slope region, which is predominantly capacitively controlled. Consequently, the obtained plateau capacity is limited to 26 mAh·g⁻¹. After three formation cycles at 0.1 C, the cell was tested at 1 C, delivering a capacity of 112 mAh·g⁻¹ at 300^{th} cycle. These capacity values are lower than those of pre-treated asphaltene-derived hard carbons, highlighting the significance of the pre-treatment process in enhancing electrochemical performance. In particular, the half-cell studies reveal that the HN-ASP-1500 anode outperforms other anodes, demonstrating superior electrochemical properties. Unattractive interlayer spacing (0.347 nm) and ordered structure, which restricts the availability of sodium active sites for the intercalation and de-intercalation processes on the RASP-HC-1500 anode. The high I.C.E., favorable capacity retention, and stable cycling behavior suggest that the HN-ASP-1500 anode is a promising candidate for sodium-ion battery applications.

The electrochemical impedance spectroscopy (EIS) Nyquist plots of the RASP-HC-1500 and HN-ASP-HC-1500 anodes in a half-cell configuration, recorded before and after the 300^{th} charge at 1 C, are provided in FIG. 16 a-b. The Nyquist plot of the RASP-HC-1500 anode (FIG. 16a) exhibits an internal resistance (Rₛ) of 7.2Ω, which increases slightly to 7.7Ω after 300^{th} charge. The slope angle in the low-frequency region remains nearly unchanged at 80°, suggesting that the charge storage process remains capacitive-controlled. Furthermore, the charge transfer resistance (R_{ct}) of the RASP-HC-1500 anode does not exhibit any significant variation, indicating stable electrochemical kinetics over prolonged cycling. In contrast, the HN-ASP-HC-1500 anode (FIG. 16b) initially shows Rₛ=9Ω and R_{ct}=4Ω, with a slope angle of 78° in the low-frequency region. After 300^{th} charge, the Nyquist plot reveals the appearance of two semicircles, corresponding to the formation of the solid electrolyte interphase (SEI) and charge transfer resistance. The Rₛ value decreased to 2.5Ω, while the R_{ct} value increased slightly to 15Ω. Additionally, the slope angle decreases to 50°, which suggests a transition from capacitive to diffusion-controlled charge storage behavior.

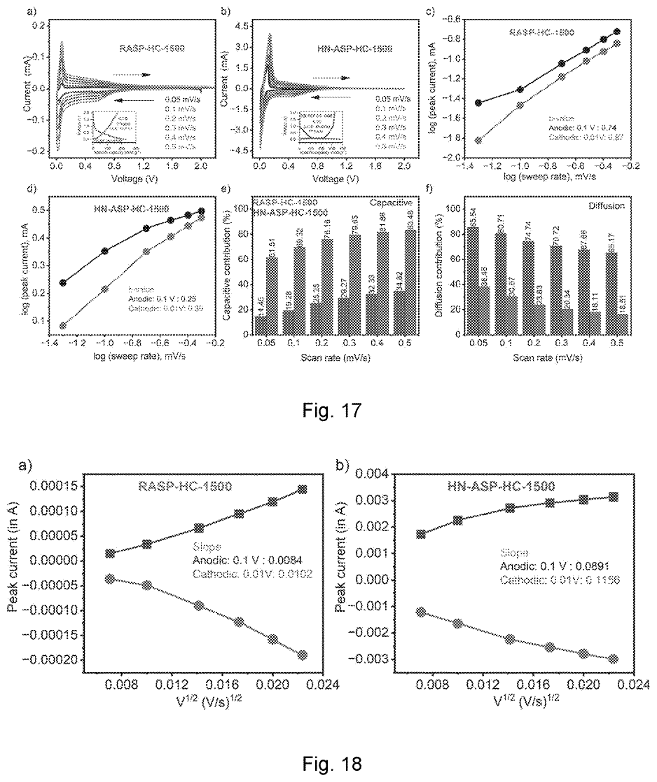

The b-value, capacitive and diffusion contributions, and diffusion coefficient values were determined from the CV curves of RASP-HC-1500 and HN-ASP-HC-1500 anodes at varying scan rates (0.05-0.5 mV s⁻¹), as presented in FIG. 17 a, b. The obtained sodiation/de-sodiation peak intensity values increase and maintain the peak position with a slight shift when increasing scan rates, indicating the electrochemical stability of the anodes at higher current rates. The b-value is determined from the slope of the log (sweep rate) vs. log (peak current) curve, as shown in FIG. 17 c, d. Generally, b-value close to 0.5 indicates a diffusion-controlled process, whereas a value near 1 corresponds to a capacitive-controlled process. Here, the b-value is calculated from the sodiation peak currents at 0.01 V in the cathodic region and the de-sodiation peak at 0.1 V in the anodic region across different scan rates. The calculated b-value for the RASP-HC-1500 anode is 0.74 (anodic) and 0.91 (cathodic), suggesting a capacitive-dominated process. In contrast, the HN-ASP-HC-1500 anode exhibits b-values closer to 0.5 (0.25 anodic and 0.39 cathodic), indicating a diffusion-dominated process. Further, capacitive and diffusion contribution of the anodes were evaluated using Dunn's method with the following equation:

i(V)=k₁v+k₂v^{1/2} (1)

Where i(V) is the current in amperes at fixed voltage, k1 and k2 are constant correspond to the capacitive and diffusion, and v is the scan rate. The k1 and k2 values are slope and intercept values, which is obtained from the v^{1/2} vs. i/v^{1/2} curves. The calculated capacitive and diffusion contributions at different scan rates are displayed in FIG. 17 e, f. At 0.05 mV s⁻¹, the RASP-HC-1500 anode exhibits a higher capacitive contribution (61.51%) compared to the HN-ASP-HC-1500 anode (14.45%), as shown in FIG. 17e. The capacitive contribution of RASP-HC-1500 further increases with increasing scan rates, reaching 83.48% at 0.5 mV s⁻¹. In contrast, the HN-ASP-HC-1500 anode shows a capacitive contribution of 34.82% at 0.5 mV s⁻¹. The diffusion contribution is higher for the HN-ASP-HC-1500 anode, with a value of 85.54% at 0.05 mV s⁻¹, decreasing to 65.17% at 0.5 mV s⁻¹ (FIG. 17f). In comparison, the RASP-HC-1500 anode exhibits inferior diffusion behavior, contributing 38.48% at 0.05 mV s⁻¹ and only 16.51% at 0.5 mV s⁻¹. These results indicate that the HN-ASP-HC-1500 anode follows a more diffusion-dominated charge storage process, whereas the RASP-HC-1500 anode demonstrates a predominantly capacitive-controlled behavior. The diffusion co-efficient values of the anode were calculated using Randles-Sevick's equation which is described below:

$${i}_{p} = 2.69 \times {10}^{5} {n}^{3 / 2} {v}^{1 / 2} {D}^{1 / 2} AC \qquad ( 2 )$$

$$D = {[ ( \frac{{i}_{p}}{{v}^{1 / 2}} ) ( \frac{1}{2.69 \times {10}^{5} {n}^{3 / 2} AC} ) ]}^{2} \qquad ( 3 )$$

Where ip is intensity of the peaks in ampere, v is the scan rate in voltage s⁻¹, n is number of sodium ion transfer (n=1), D is the diffusion co-efficient in cm²/s, A is the electrode area in cm², C is concentration in mol/dm3. The

$$( \frac{{i}_{p}}{{v}^{1 / 2}} )$$

value has been evaluated from the slope of v^{1/2} vs. iₚ curves, as depicted in FIG. 18 a-b. The calculated diffusion coefficient of the HN-ASP-HC-1500 anode is 4.68×10⁻⁸ cm² s⁻¹ from the anodic peak at 0.1 V and 7.90×10⁻⁸ cm² s⁻¹ from the cathodic peak at 0.01 V. These values are higher than those of the RASP-HC-1500 anode, which exhibits diffusion coefficients of 4.19×10⁻¹⁰ cm² s⁻¹ and 6.14×10⁻¹⁰ cm² s⁻¹ for the anodic and cathodic peaks, respectively. The enhanced diffusion coefficient of the HN-ASP-HC-1500 anode is likely attributed to its larger interlayer spacing (0.376 nm) compared to the RASP-HC-1500 anode (0.347 nm).

### Ex-Situ Characterization of Asphaltenes Derived Hard Carbon Anode in SIBs

Ex-situ XRD and XPS characterization of the RASP-HC-1500 and HN-ASP-HC-1500 anode surfaces under different charging conditions at 0.1 C are presented in FIG. 7 a-d. A freshly coated RASP-HC-1500 anode has a d-spacing of 0.350 nm, which increases to 0.362 nm after the first discharge at 0.1 C due to sodium-ion intercalation (FIG. 7a). Upon the first charge, the d-spacing decreases to 0.354 nm, which can be attributed to the deintercalation of sodium ions. FIG. 7b presents the response of the HN-ASP-HC-1500 anode under coated, first discharge, and charging conditions at 0.1 C. The freshly prepared HN-ASP-HC-1500 anode has a d-spacing of 0.375 nm, which slightly increases to 0.382 nm during sodium-ion intercalation and nearly returns to its initial value after deintercalation. The higher interlayer spacing facilitates sodium-ion transport; however, it does not significantly affect the d-spacing during 1^{st} cycling.

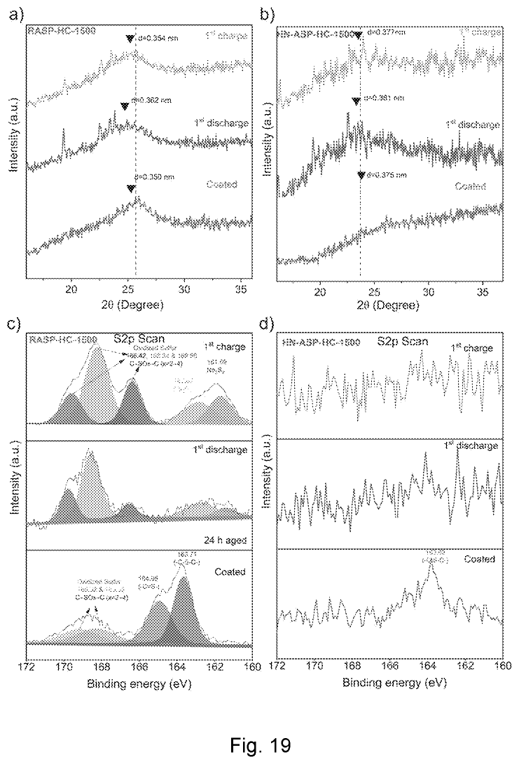

FIGS. 19 c-d show the high-resolution S2p scan of the RASP-HC-1500 anode and the HN-ASP-HC-1500 anode under similar charging conditions. Significant surface changes are observed in the RASP-HC-1500 anode compared to the HN-ASP-HC-1500 anode. The coated RASP-HC-1500 anode exhibits four peaks at 163.71, 164.95, 168.32, and 169.33 eV, corresponding to the presence of —C—S—C—, —C═S—, and oxidized sulfur (C—SOₓ—C), respectively. Upon the first discharge, the formed —C—S—C— and —C═S— bonds undergo oxidation, introducing peaks at 166.42, 168.34, and 169.66 eV, along with the formation of sodium polysulfides (NaₓS_{y}), identified by the appearance of peaks at 161.69 and 162.87 eV. The intensity of the oxidized sulfur and polysulfide peaks increase after the first charge. CHNS analysis (Table 4) reveals that the sulfur content in the RASP-HC-1500 anode is 1.85 wt. %, whereas sulfur is undetectable in the HN-ASP-HC-1500 anode. However, the high-resolution scan of the HN-ASP-HC-1500 anode (FIG. 19d) shows a tiny broad peak at 163.83 eV, corresponding to the —C—S—C— bond, indicating the presence of trace amounts of sulfur. It indicates the presence of a trace amount of sulfur in the HN-ASP-HC-1500 anode, with no detectable peak appearance after the first discharge and charging cycles. This oxidation likely occurs at trace levels during cycling, making it undetectable in the XPS scans. The present disclosure reveals that side reactions occur on the surface of the RASP-HC-1500 anode, influencing its initial coulombic efficiency (I.C.E.), which is lower (74.8%) than that of the HN-ASP-HC-1500 anode (85.03%) (FIG. 12a).

### Full-Cell Performances of Asphaltenes Derived Hard Carbon Anode in SIBs

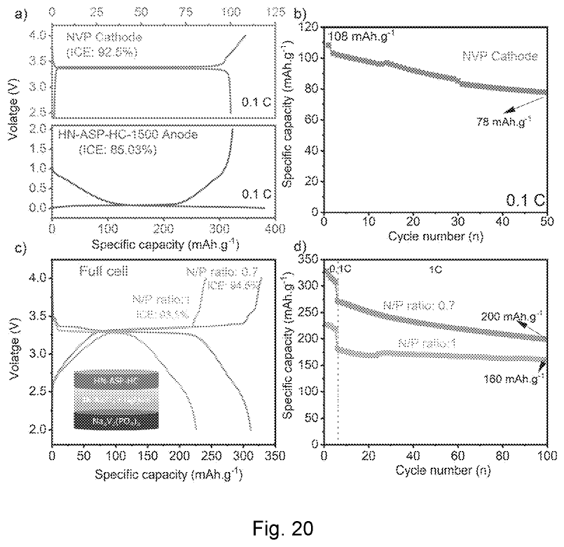

The preliminary full-cell studies were conducted using the configuration HN-ASP-HC-1500|100 μL of 1 M NaPF₆ in diglyme|Na₃V₂(PO₄)₃, and the corresponding results are depicted in FIG. 20 a-d. FIG. 20a compares the initial charge-discharge profiles of the half-cell configurations of the hard carbon anode and the Na₃V₂(PO₄)₃ cathode, cycled at 0.1 C. The initial Coulombic efficiency (I.C.E.) of the Na₃V₂(PO₄)₃ cathode is 92.5%, while the HN-ASP-HC-1500 anode exhibits 85.03%. The Na₃V₂(PO₄)₃ cathode delivers a capacity of 100 mAh·g⁻¹ after the formation cycle, which slightly fades to 78 mAh·g⁻¹ by the 50^{th} cycle, resulting in a capacity retention of 75.7%, as shown in FIG. 20b. In contrast, the hard carbon anode achieves 94.6% capacity retention in the 50^{th} cycle in the half-cell configuration (FIG. 20c). Full cells were fabricated with two different N/P (negative/positive electrode) ratios of 0.7 and 1.0, using a cathode capacity of 100 mAh·g⁻¹ and an anode capacity of 310 mAh·g⁻¹ (FIGS. 20c and 209d). The charge-discharge experiments were performed using a current density based on the anode weight and both full cells (N/P=0.7 and N/P=1.0) exhibited a similar I.C.E. of 94.5%. However, the lower N/P ratio (0.7) resulted in a higher capacity of 310 mAh·g⁻¹, whereas the higher N/P ratio (1.0) delivered 225 mAh·g⁻¹ after the formation cycle. The cells were cycled at 1 C after stabilizing for five cycles at 0.1 C, as shown in FIG. 20d. The full cell with N/P=0.7 delivered an initial capacity of 273 mAh·g⁻¹, which gradually decreased, reaching 200 mAh·g⁻¹ after 100 cycles, with a capacity retention of 73.2%. Meanwhile, the N/P=1.0 cell delivered 183 mAh·g⁻¹ after stabilization and exhibited a capacity retention of 86.8%. The observed capacity degradation and cycling performance limitations are primarily attributed to the poor electrochemical performance of the Na₃V₂(PO₄)₃ cathode, as shown in FIG. 20b. Nevertheless, the promising electrochemical performance of the HN-ASP-HC-1500 anode highlights its potential as an anode material for sodium-ion battery applications. The HN-ASP-HC-1500 anode may be further optimized with a suitable cathode formulation and electrolyte to enhance its viability for practical sodium-ion battery applications.

While specific embodiments of the disclosure have been described and illustrated, such embodiments should be considered illustrative only and not as limiting the invention as construed in accordance with the accompanying claims.

What is claimed is:

1. A method for forming hard carbon, the method comprising:
oxidizing an asphaltene precursor in an oxygen-rich atmosphere at one or more temperatures to produce an oxidized asphaltene; and
carbonising the oxidized asphaltene at an elevated temperature under an inert atmosphere to produce hard carbon having an interlayer spacing suitable for sodium-ion intercalation.

2. The method of claim 1, wherein the oxygen-rich atmosphere is air.

3. The method of claim 1, wherein oxidizing comprises heating the asphaltene precursor at a plurality of temperatures.

4. The method of claim 3, wherein oxidizing comprises heating the asphaltene precursor to a first temperature and maintaining the first temperature for a first period, and subsequently heating to a second temperature higher than the first temperature and maintaining the second temperature for a second period.

5. The method of claim 4, wherein the first temperature is about 260° C. and the second temperature is about 800° C.

6. The method of claim 1, wherein oxidizing is conducted at a temperature in the range of 260° C. to 800° C.

7. The method of claim 1, further comprising milling the asphaltene precursor or the oxidized asphaltene to a powder, wherein the milling is performed at one or more of: prior to acid treatment, after acid treatment, after oxidizing, or after carbonising.

8. The method of claim 1, wherein carbonising is conducted at a temperature in the range of 1200° C. to 1800° C.

9. The method of claim 8, wherein carbonising is conducted at a temperature of about 1500° C.

10. The method of claim 1, wherein carbonising is conducted for a period of time selected to be between 5 minutes and 5 hours.

11. The method of claim 1, wherein carbonising is conducted at a heating rate selected to be between about 0.5° C. and 10° C. per minute.

12. The method of claim 1, wherein the inert atmosphere comprises an inert gas.

13. The method of claim 1, further comprising oxidizing the asphaltene precursor with an oxidizing agent prior to oxidizing in an oxygen-rich atmosphere at one or more temperatures.

14. The method of claim 13, wherein the acid comprises an acid.

15. The method of claim 1, wherein the hard carbon is for use in sodium-ion battery anodes.

16. The method of claim 1, wherein the hard carbon has a carbon content of at least 85 wt. %.

17. The method of claim 1, wherein the hard carbon has a sulfur content of less than 5 wt. %.

18. The method of claim 1, wherein the hard carbon has a nitrogen content of less than 5 wt. %.

19. The method of claim 1, wherein the hard carbon has an oxygen content of less than 10 wt. %.

20. A sodium-ion battery comprising an anode formed from hard carbon produced by the method of claim 1.
